(19) United States
(12) Patent Application Publication
(10) Pub. No.: US 2013/0125701 A1
(43) Pub. Date: May 23, 2013

(54) VARIABLE COMPRESSION RATIO DEVICE

(71) Applicants: Yoonsik Woo, Yongin-si (KR); Juhun Lee, Gwangmyeong-si (KR); Eunho Lee, Hwaseong-si (KR); Jinkook Kong, Suwon-si (KR); Soohyung Woo, Yongin-si (KR)

(72) Inventors: Yoonsik Woo, Yongin-si (KR); Juhun Lee, Gwangmyeong-si (KR); Eunho Lee, Hwaseong-si (KR); Jinkook Kong, Suwon-si (KR); Soohyung Woo, Yongin-si (KR)

(73) Assignee: Hyundai Motor Company, Seoul (KR)

(21) Appl. No.: 13/528,603

(22) Filed: Jun. 20, 2012

(30) Foreign Application Priority Data
Nov. 22, 2011 (KR) 10-2011-0122082

(51) Int. Cl. F16C 7/06

(52) U.S. Cl. 74/586

(57) ABSTRACT

A variable compression ratio (VCR) device, may include a cone rod, an upper end portion thereof being rotatably coupled to a piston pin to be connected to a piston, dual eccentric links eccentrically coupled to the piston pin, wherein each of the dual eccentric links may be placed on lateral sides of the upper end portion in the cone rod having a lower end portion coupled to a crankshaft, and dual swing links, one end of each of the dual swing links being engaged to a control shaft of an actuator and the other end of each of the dual swing links being connected to lower portions of the dual eccentric links.

### CROSS-REFERENCE TO RELATED APPLICATIONS

The present application claims priority to Korean Patent Application Number 10-2011-0122082 filed Nov. 22, 2011, the entire contents of which application is incorporated herein for all purposes by this reference.

### BACKGROUND OF THE INVENTION

1. Field of the Invention

The present invention relates to a variable compression ratio (VCR) device, and more particularly, to a VCR device which has an advantage in load balancing through dual variable links and dual eccentric links and does not require a trace guide structure for a cone rod following a motion of a piston.

2. Description of Related Art

In general, when a mixture compression ratio of an engine is changed properly according to an operation state of the engine, engine power as well as fuel efficiency may be improved.

The mixture compression ratio which is changed properly is referred to as a VCR, and a VCR device implements the VCR.

Typically, a VCR device improves fuel efficiency by increasing a compression ratio of a mixture in a low load condition of the engine, and prevents the occurrence of knocking and improves engine power by lowering the compression ratio of the mixture in a high load condition of the engine.

However, when the VCR device is simply controlled under the low load condition or the high load condition, only a compression ratio of the mixture which is set according to the operation state of the engine is implemented even though the VCR device is applied, and an intake stroke, a compression stroke, an explosion stroke, and an exhaust stroke are not set in different manners.

Therefore, in such a method, thermal efficiency may be further increased when the expansion stroke is set to be longer than the compression stroke. However, there are difficulties in making the expansion stroke longer than the compression stroke.

In particular, in order to implement high fuel efficiency and a high power engine, a high compression ratio and a low engine displacement need to be implemented in a low load condition, and a low compression ratio and a high engine displacement need to be implemented in a high load condition. However, there are difficulties in implementing them in the above-described method.

Accordingly, in order to overcome the defect of the method which changes only two compression ratios as described above, technology development in many different fields is being conducted on a method which continuously changes a compression ratio over the entire region.

For example, there is provided a VCR device which includes multiple joints constructed by using a variable link connected to an eccentric link between a crankshaft and a piston reciprocating inside a combustion chamber, and forms a level difference of the piston using the motions of the multiple joints having the variable links, thereby changing a VCR of the combustion chamber in various manners.

As such, the multiple joints having the variable link connected to the eccentric link are used to control the operation region of an engine according to at least three different VCRs, and the rotation radius of the crankshaft deciding the engine power is changed. Accordingly, the efficiency may be further improved than when the engine is operated according to two different VCRs.

In the above-described manner, however, one side of the variable link is connected to the eccentric link, and the other side thereof is connected to a control shaft of an actuator. Therefore, there are many limits in terms of the structure.

For example, since the variable link should have the shape of a connecting rod so as to be connected to the control shaft of the actuator, the variable link has a disadvantage in the weight thereof. In particular, as the eccentric link and the control shaft are coupled to each other, the variable link has a disadvantage in control load balancing.

Further, in the above-described manner, the variable link has a structure which is dependent on the motion of the connecting rod coupled to the piston and crankshaft. Therefore, a guide structure capable of guiding the motion traces of the variable link and the eccentric link with respect to the connecting rod connected to the piston is inevitably required.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a VCR device which includes dual swing links and eccentric links such that the motion traces of the swing links and the eccentric links are guided by the swing links, more favourably implements load balancing even though the dual swing links are connected to an actuator through a control shaft, and significantly increases the precision of compression ratio variable control through the dual structure.

In an aspect of the present invention, a variable compression ratio (VCR) device, may include a cone rod, an upper end portion thereof being rotatably coupled to a piston pin to be connected to a piston, dual eccentric links eccentrically coupled to the piston pin, wherein each of the dual eccentric links is placed on lateral sides of the upper end portion in the cone rod having a lower end portion coupled to a crankshaft, and dual swing links, one end of each of the dual swing links being engaged to a control shaft of an actuator and the other end of each of the dual swing links being connected to lower portions of the dual eccentric links.

The one end of each of the dual swing links is engaged to the control shaft of the actuator via a control link.

The dual eccentric links may have vertical symmetry with respect to a longitudinal axis of the cone rod, and the dual swing links are connected to the lower portions of the dual eccentric links having vertical symmetry with respect to the longitudinal axis of the cone rod.

The cone rod is disposed between the dual eccentric links and the dual eccentric links may include a left eccentric link positioned at a lateral side surface of the cone rod and a right eccentric link positioned at the other lateral side surface of the cone rod.

The left and right eccentric links may have holes formed therein, through which the piston pin passes.

The dual swing links may include a pair of link connection parts which are divided into two parts from one side of a body thereof and extended so as to be pivotally connected to the dual eccentric links, respectively.

The link connection parts are positioned and fixed inside the left and right eccentric links.

The dual swing links may include a pair of input connection parts which are divided into two parts from the opposite side of the body thereof connected to the dual eccentric links, and connected to the control shaft of the actuator.

The pair of input connection parts may have holes formed therein, through which an input connection pin passes, and the input connection pin is engaged to the control shaft of the actuator via a control link.

According to the exemplary embodiments of the present invention, as the trace guide structure for motion is implemented through the dual swing links, the tract guide structure does not need to be implemented through the cone rod connected to the piston. Further, although the dual swing links are connected to the actuator through the control shaft, load balancing may be more favourably implemented. In addition, the precision of the compression ratio variable control may be significantly increased by enhancement of control precision by the dual structure.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIGS. 1A and 1B are a construction diagram of a VCR device according to an exemplary embodiment of the present invention.

FIG. 2 illustrates a state in which a piston is mounted in the VCR device according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

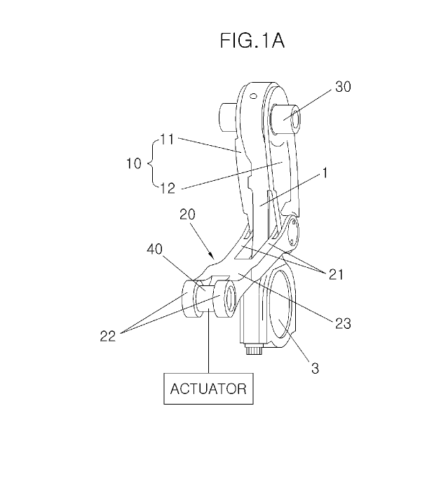

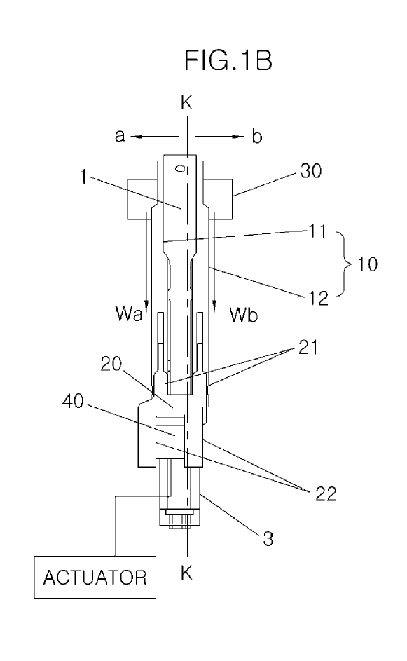

Referring to FIG. 1A, a VCR device includes dual eccentric links 10 and dual swing links 20. Dual eccentric links 10 are eccentrically coupled to each other through a piston pin 30 connected to a piston through a cone rod 1 so as to surround the thickness of cone rod 1, and dual swing links 20 are connected to a control shaft 50 of an actuator and connected to the lower portion of dual eccentric links 10.

The top of cone rod 1 is coupled to a piston 2 through piston pin 30, and the bottom of cone rod 1 is coupled to a crankshaft 3 such that a reciprocating motion of piston 2 is converted into a rotating motion of crankshaft 3.

Dual eccentric links 10 include a pair of left eccentric link 11 and right eccentric link 12 which have the same shape and structure. Left and right eccentric links 11 and 12 have a hole 35 formed in the upper portion thereof, through which piston pin 30 passes, and a hole 38 formed in the lower portion thereof, which is coupled to dual swing links 20.

Dual swing links 20 include a pair of link connection parts 21 and a pair of input connection parts 22. Link connection parts 21 are extended while divided into two parts from one side of a body 23 thereof having a predetermined thickness, and input connection parts 22 are extended while divided into two parts from the opposite side of the body.

Link connection parts 21 have a protrusion or hole formed at an end thereof, and input connection parts 22 have a hole formed therein.

In the present exemplary embodiment of the present invention, link connection parts 21 are coupled to the holes formed through the lower portions of left and right eccentric links 11 and 12 of dual eccentric links 10, and input connection parts 22 are coupled to control shaft 50 through an input connection pin 40 passing through input connection parts 22.

Referring to FIG. 1B, left eccentric link 11 of dual eccentric links 10 is closely attached and fixed to one side surface (referred to as a left side surface) of cone rod 1 through piston pin 30 at piston 2, and right eccentric link 12 is closely attached and fixed to the other side surface (referred to as a right side surface) of cone rod 1 facing the left side surface.

On the other hand, as dual swing links 20 are coupled to the holes formed through the lower portions of left and right eccentric links 11 and 12 of dual eccentric links 10 through link connection parts 21, dual swing links 20 are connected to dual eccentric links 10. Dual swing links 20 are connected to the actuator through input connection parts 22 forming the opposite portion of link connection parts 21.

Here, link connection parts 21 are positioned inside left and right eccentric links 11 and 12 of dual eccentric links 10.

As control shaft 50 operating as an output shaft is coupled to input connection pin 40 passing through the holes 45 formed in input connection parts 22 of dual swing links 20, the power of the actuator is transmitted to dual swing links 20.

As described above, dual eccentric links 10 are divided into left and right eccentric links 11 and 12 surrounding the thickness of cone rod 1, and dual swing links 20 are assembled to left and right eccentric links 11 and 12, respectively.

Accordingly, as dual eccentric links 10 are connected to cone rod 1 coupled to piston 2 and dual swing links 20 as well as dual eccentric links 10 are connected to the actuator through control shaft 50, the VCR device is constructed with connecting rod 1.

Therefore, in the present exemplary embodiment of the present invention, left and right parts a and b of the VCR device may be symmetrical with respect to the center K of cone rod 1. Such a symmetrical structure may implement load balancing in which the VCR device has a balanced weight with respect to the center K of cone rod 1.

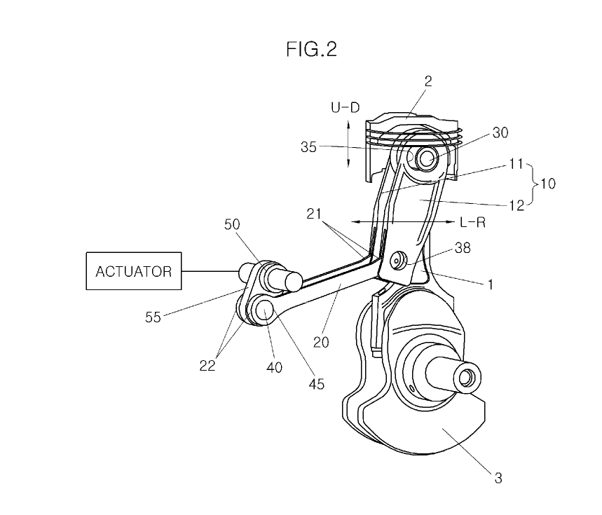

Referring to FIG. 2, the VCR is implemented as follows: as the torque of control shaft 50 caused by the operation of the actuator is transmitted to input connection pin 40 via a control link 55 to move input connection parts 22 coupled thereto, dual swing links 20 are pulled or pushed, that is, a motion L-R occurs.

The motion of dual swing links 20 is transmitted to left and right eccentric links 11 and 12 through link connection parts 21 such that the motion L-R occurs in the same direction. As the motion L-R of left and right eccentric links 11 and 22 is transmitted to cone rod 1 through piston pin 30, a motion U-D of piston 2 is also changed.

The above-described change in motion U-D of piston 2 changes the level of piston 2, thereby varying the compression ratio of a combustion chamber.

The variable control of the compression ratio of the combustion chamber is implemented by applying typical control logic.

As described above, the VCR device according to the exemplary embodiment of the present invention includes dual eccentric links 10 which are assembled through piston pin 30 while surrounding the thickness of the upper end portion of cone rod 1 coupled to piston 2, unlike the lower end portion coupled to crankshaft 3, and dual swing links 20 which are connected to control shaft 50 of the actuator and connected to the lower portions of dual eccentric links 10.

In particular, dual eccentric links 10 and dual swing links 20 have vertical symmetry and load balancing with respect to the center of cone rod 1.

Therefore, a structure for guiding the motion trace of cone rod 1 is not required, and the entire load balancing of the actuator with respect to control shaft 50 is more easily implemented. In particular, the precision of the compression ratio variable control through the dual structure is significantly increased.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

1. A variable compression ratio (VCR) device, including:
a cone rod, an upper end portion thereof being rotatably coupled to a piston pin to be connected to a piston;
dual eccentric links eccentrically coupled to the piston pin, wherein each of the dual eccentric links is placed on lateral sides of the upper end portion in the cone rod having a lower end portion coupled to a crankshaft; and
dual swing links, one end of each of the dual swing links being engaged to a control shaft of an actuator and the other end of each of the dual swing links being connected to lower portions of the dual eccentric links.

2. The VCR device as defined in claim 1, wherein the one end of each of the dual swing links is engaged to the control shaft of the actuator via a control link.

3. The VCR device as defined in claim 1, wherein the dual eccentric links have vertical symmetry with respect to a longitudinal axis of the cone rod, and the dual swing links are connected to the lower portions of the dual eccentric links having vertical symmetry with respect to the longitudinal axis of the cone rod.

4. The VCR device as defined in claim 1, wherein the cone rod is disposed between the dual eccentric links and the dual eccentric links include a left eccentric link positioned at a lateral side surface of the cone rod and a right eccentric link positioned at the other lateral side surface of the cone rod.

5. The VCR device as defined in claim 4, wherein the left and right eccentric links have holes formed therein, through which the piston pin passes.

6. The VCR device as defined in claim 1, wherein the dual swing links include a pair of link connection parts which are divided into two parts from one side of a body thereof and extended so as to be pivotally connected to the dual eccentric links, respectively.

7. The VCR device as defined in claim 6, wherein the link connection parts are positioned and fixed inside the left and right eccentric links.

8. The VCR device as defined in claim 1, wherein the dual swing links include a pair of input connection parts which are divided into two parts from the opposite side of the body thereof connected to the dual eccentric links, and connected to the control shaft of the actuator.

9. The VCR device as defined in claim 8, wherein the pair of input connection parts have holes formed therein, through which an input connection pin passes, and the input connection pin is engaged to the control shaft of the actuator via a control link.
